(19) United States
(12) Patent Application Publication
(10) Pub. No.: US 2007/0210601 A1
(43) Pub. Date: Sep. 13, 2007

(54) Vehicle panel and seat assembly

(76) Inventors: Brian D. Phillips, Almont, MI (US); Mohammad Saberan, New Baltimore, MI (US); James Klein, Rochester Hills, MI (US); David Kolena, Bloomfield Hills, MI (US); Kyle Calvert, Sterling Heights, MI (US); Paul J. Glinka, Waterford, MI (US); Sanjay Vakil, Troy, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/374,513

(22) Filed: Mar. 13, 2006

(51) Int. Cl. B60R 5/00

(52) U.S. Cl. 296/37.14

(57) ABSTRACT

A panel assembly for covering a storage recess in a vehicle floor includes a base panel and an extension panel. The base panel is adapted to be movable relative to the recess to cover a first portion of the recess. The extension panel is slidably mounted on the base panel and movable with the base panel. The extension panel is slidable between a retracted position in which a portion of the extension panel is adjacent the base panel, and an extended position such that the portion of the extension panel extends outwardly from the base panel and is adapted to cover a second portion of the recess.

### BACKGROUND OF THE INVENTION

This invention relates in general to vehicle load floors, and in particular to a panel assembly for covering a recess formed in a vehicle floor for the storage of a foldable seat assembly.

It is becoming increasing popular to manufacture seating assemblies which can be easily removed from the interior of the vehicle to provide additional room within the interior of the vehicle. It is also known to include seats which are movable between an upright position for supporting an occupant and a stowed position in which the seat is folded in a more compact form. Some vehicles include recesses formed in the floor for receiving one or more folded vehicle seats, thereby hiding or storing the seat without having to remove the seat from the vehicle. It is also known to use a relatively flat panel to cover the recess when the seat is in its upright or stowed position. The panel creates a load floor such that items can be placed thereon and occupants can rest their feet or walk over the panel to move within the interior of the vehicle.

In one known arrangement, a double hinged panel is provided which covers the recess when the seat is in its upright position. The hinged panel includes a rectangular shaped first panel hinged to a rectangular shaped second panel. One edge of the first panel is pivotally mounted on the floor and the other opposed edge is hingedly attached to the second panel. The first panel covers a first portion of the recess, and the second panel covers a second portion of the recess. Both panels of the hinged panel are manually lifted to expose the recess such that the seat can be moved to a stowed position within the recess. The panels are then manually moved over the recess, thereby providing a load floor above the recess and seat.

### SUMMARY OF THE INVENTION

This invention relates to a panel assembly for covering a storage recess in a vehicle floor includes a base panel and an extension panel. The base panel is adapted to be movable relative to the recess to cover a first portion of the recess. The extension panel is slidably mounted on the base panel and movable with the base panel. The extension panel is slidable between a retracted position in which a portion of the extension panel is adjacent the base panel, and an extended position such that the portion of the extension panel extends outwardly from the base panel and is adapted to cover a second portion of the recess.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a vehicle assembly including a movable seat assembly and movable panel assembly.

FIG. 2 is a side view shown partially in section of the vehicle assembly of FIG. 1.

FIG. 3 is a perspective view of the vehicle assembly of FIG. 1, wherein the seat back of the seat assembly is shown in its lowered position, and the extension panel of the panel assembly is shown in its retracted position.

FIG. 4 is a perspective view of the vehicle assembly of FIG. 1, wherein the seat assembly is shown in its stowed position, and the base panel of the panel assembly is shown in its lifted position.

FIG. 5 is a side view shown partially in section of the vehicle assembly in the configuration shown in FIG. 4.

FIG. 6 is a perspective view of the vehicle assembly of FIG. 1, wherein the seat assembly is shown in its stowed position, the base panel is shown in its lowered position, and the extension panel is shown in its retracted position.

FIG. 7 is a perspective view of the vehicle assembly of FIG. 1, wherein the seat assembly is shown in its stowed position, the base panel is shown in its lowered position, and the extension panel is shown in its extended position, thereby defining a load floor.

FIG. 8 is a schematic side view of an alternate embodiment of a panel assembly having a base panel and an extension panel pivotally mounted on the base panel.

FIG. 9 is a schematic side view of the panel assembly of FIG. 8, wherein the extension panel is shown in its retracted position adjacent the base panel.

FIG. 10 is a schematic side view of the panel assembly of FIG. 8, wherein the base panel is shown in its lifted position.

### DETAILED DESCRIPTION OF THE PREFERRED EMBODIMENT

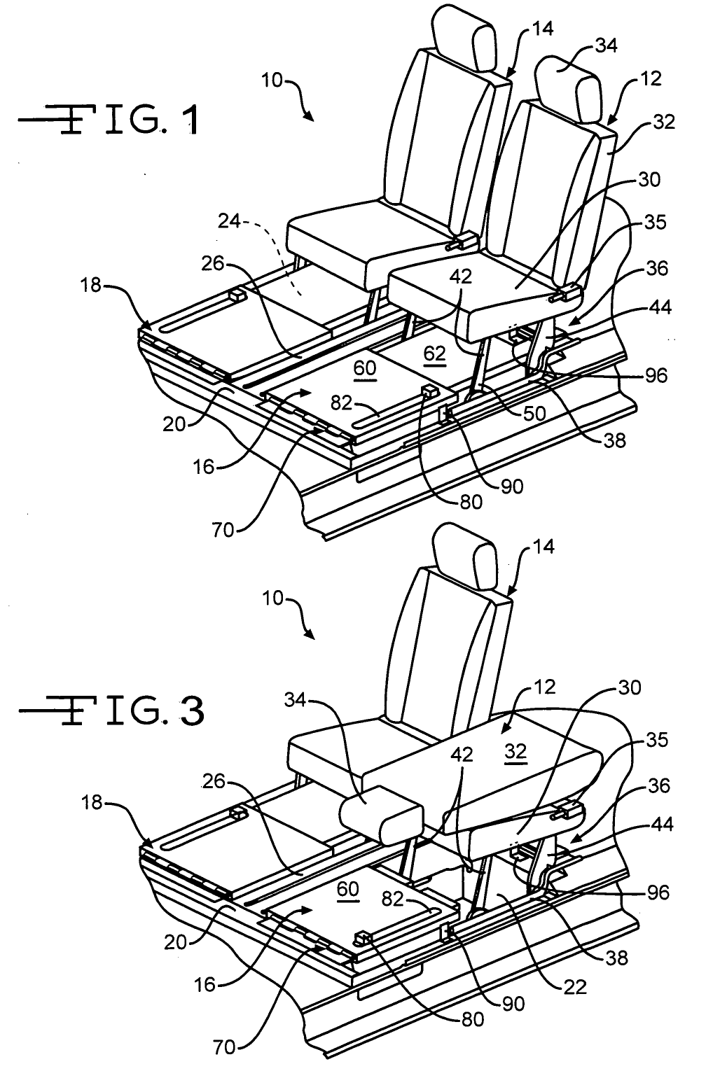

Referring now to the drawings, there is illustrated in FIG. 1 a vehicle assembly, indicated generally at 10. The assembly 10 generally includes a first seat assembly 12, a second seat assembly 14, a first panel assembly 16, a second panel assembly 18, and a vehicle floor 20. The vehicle floor 20 can have any contoured shape and includes a pair of recesses 22 and 24. Note that the recess 24 is covered by the second panel assembly in FIG. 1.

As will be described below in more detail, the seat assembly 12 is movable between an upright position, as shown in FIG. 1, and a stowed position within the recess 22, as shown in FIG. 4-7. The panel assembly 16 generally covers the recess 22, thereby creating a load floor. The panel assembly 16 is preferably pivotally mounted on the floor 20 and movable to allow access to the recess 22, as will be described in greater detail below. The second seat assembly 14 may be similar in structure and function as the first seat assembly 12, and as such only the seat assembly 12 will be described in detail and shown in later Figures. Similarly, the second panel assembly 24 may be similar in structure and function as the first panel assembly 22, and as such only the panel assembly 22 will be described in detail and shown in later Figures. It should be understood that the vehicle assembly 10 can include any number of panel assemblies and seat assemblies, and oriented in any desired position on the vehicle floor 20.

In the embodiment of the floor 20 illustrated in FIG. 1, the recesses 22 and 24 are spaced from one another and separated from each other by a bridge portion 26 of the vehicle floor 20. The bridge portion 26 may be generally flush and co-planar with the adjacent portions of the vehicle floor 20 and with the panel assemblies 16 and 18. This spaced apart relationship of the recesses 22 and 24 and the bridge portion 26 provides space for components of a vehicle drivetrain assembly (not shown), such as a drive shaft (not shown), positioned under the bridge portion 26 of the vehicle floor 20. Alternatively, the recesses 22 and 24 could communicate with one another and/or be combined into a single compartment. The recesses 22 and 24 may be used as storage compartments when not occupied by the seat assemblies 12 and 14.

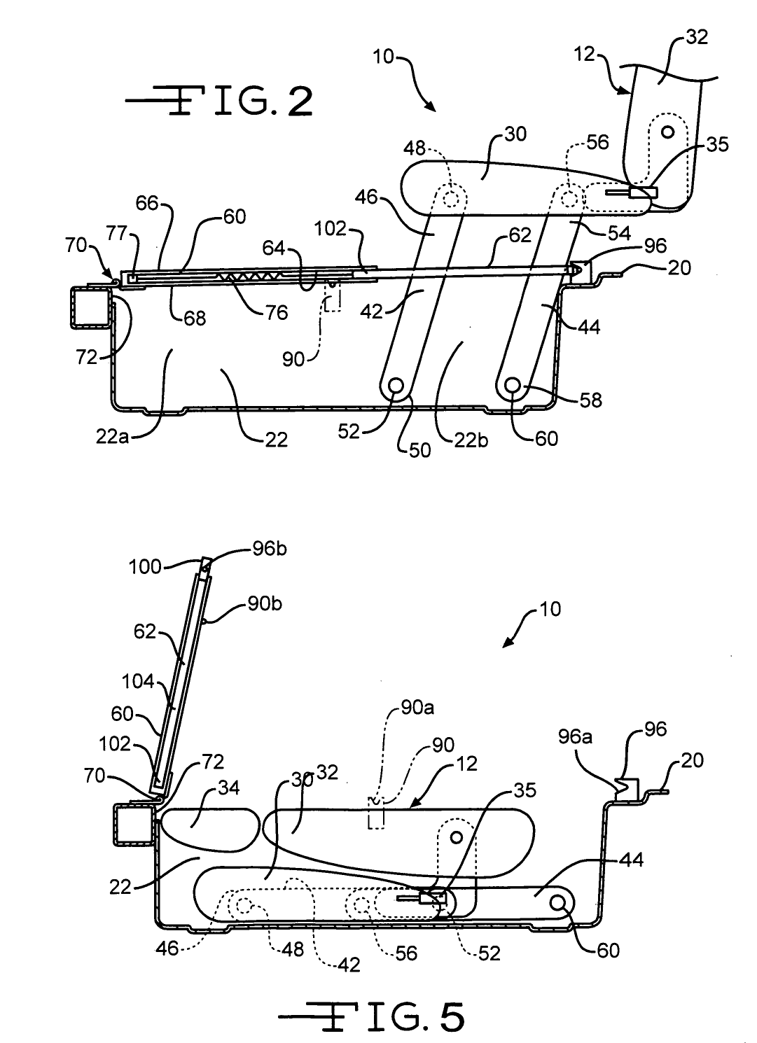

The seat assembly 12 generally includes a seat bottom 30 and a seat back 32. A head rest 34 is mounted on the upper portion of the seat back 32. The head rest 34 may be movable relative to the seat back 32 and/or may be completely removable from the seat back 32 providing clearance for ease of positioning the seat assembly 12 within the recess 22. The seat back 32 is preferably pivotally mounted on the seat bottom 30, such that the seat back 32 is movable between an upright position, as shown in FIGS. 1 and 2, and a lowered position, as shown in FIGS. 3 and 5. In the upright position, the seat back 32 provides support for an occupant seated on the seat. The seat back 32 may include a recliner mechanism (not shown) for angularly positioning the seat back 32 relative to the seat bottom 30 at any desirable angle relative to the seat bottom 30. The seat back 32 preferably includes a seat back latch, indicated schematically at 35. Upon actuation of the seat back latch 35, the seat back 32 can be moved from any of its angular upright positions to its lowered position. The seat back latch 35 may be connected to the recliner mechanism. The seat back 32 may further include a spring member (not shown) for biasing the seat back 32 to its lowered position. Thus, actuation of the seat back latch 35 will unlock the seat back 32 from its current upright position, and the spring member will automatically move the seat back to its lowered position. Alternatively, the seat back 32 may be manually moved between its upright and lowered positions.

The seat assembly 32 further includes a mounting assembly, indicated generally at 36. The mounting assembly 36 movably mounts the seat bottom 30 to the vehicle floor 20. Although the embodiment of the seat assembly 32 is shown and described as having the seat back 32 mounted on the seat bottom 32, the seat back 32 could be mounted to the mounting assembly 36 instead. The mounting assembly 36 includes a bracket 38 fixed to the vehicle floor 20. Note that for clarity purposes, the bracket 38 is not shown in FIGS. 2 and 5.

As best shown in FIGS. 2 and 5, the bracket 38 is generally C-shaped and generally surrounds a rear edge portion 40 of the recess 22. The mounting assembly 36 further includes a pair of front legs 42 and a pair of rear legs 44 attached generally at lateral sides of the seat bottom 30. The front legs 42 have upper portions 46 pivotally connected to the seat bottom 30 at pivots 48. The front legs 42 further include lower portions 50 pivotally connected to the mounting bracket 38 at pivots 52. Alternatively, the lower portions 50 could be pivotally connected to the floor 20. The rear legs 44 have upper portions 54 pivotally connected to the seat bottom 30 at pivots 56. The rear legs 44 further include lower portions 58 pivotally connected to the mounting bracket 38 at pivots 60. Alternatively, the lower portions 58 could be pivotally connected to the floor 20. The pivotal connection of the front and rear legs 42 and 44 define a pair of four bar mechanism for movably connecting the seat bottom 30 relative to the vehicle floor 20. If desired, the seat assembly 12 may includes an adjustor (not shown) for moving the seat bottom 30 in the fore and aft directions relative to the front and rear legs 42 and 44. The seat assembly 12 may also include latch mechanisms (not shown) for selectively locking the seat assembly 12 in its upright and stowed positions. Latch mechanisms (not shown) may also be used for selectively locking the seat back 32 in its upright and lowered positions.

The panel assembly 16 generally includes a base panel 60 and an extension panel 62. The extension panel 62 is movably mounted on the base panel 60 between a retracted position, as shown in FIGS. 3-6, and an extended position, as shown in FIGS. 1, 2, and 7. The extension panel 62 is preferably slidably mounted on the base panel 60. More preferably, the extension panel 62 is slidably disposed in a recess 64 formed in the base panel 60. The extension panel 62 may be completely disposed in the base panel 60. For example, as shown in FIG. 2, the base panel 60 may include an upper plate 66 and a lower plate 68 such that the recess 64 defines a hollow interior of the base panel 60 between the plates 66 and 68. The base panel 60 may also include side portions joining lateral edges of the plates 66 and 68 together. Alternatively, instead of the recess 64 defining a hollow interior such that the extension panel 62 is sandwiched between the plates 66 and 68, the base panel 60 could be formed of a single plate-like structure having a generally flat recess formed therein housing the extension panel 62. Thus, the extension panel 62 could be positioned underneath or on top of the base panel 60. In another alternate embodiment, the base panel 60 may not include any form of a recess and the extension panel 62 is mounted on an outer surface thereof.

The base panel 60 is preferably pivotally mounted relative to the vehicle floor 20 and movable between a lowered position, as shown in FIGS. 1-3, 6, and 7, and a lifted position, as shown in FIGS. 4 and 5. The base panel 60 may be pivotally connected to the floor 20 by any suitable mechanism, such as a hinge assembly 70. The hinge assembly 70 is attached to the floor 20 adjacent an upper front edge 72 of the recess 22. Preferably, the hinge assembly 70 includes a biasing member, such as a spring loaded hinge (not shown) for biasing the base panel 60 towards its lifted position. The base panel 60 may be moved manually or may include other devices, such as hydraulic, pneumatic, and electrical actuators for moving the base panel 60 between its lowered and lifted positions. Although the base panel 60 is shown and described as being pivotally mounted on the floor 20, it may be mounted by any method, such as for example, slidably mounted. Alternatively, the base panel 60 may not be mounted on the floor 20 so that the user may easily remove the base panel 60. For example, the base panel 60 may simply rest on the floor 20 or within a recess formed in the floor 20.

The panel assembly 16 preferably includes a spring member, schematically shown at 76 in FIG. 2, for biasing the extension panel 62 towards its retracted position. The spring member 76 can be any suitable spring mechanism such as a coil spring connected on one end to the base panel 60 and the other end connected to the extension panel 62. The spring member 76 can be housed within a passageway or recess (not shown) formed in the extension panel 62. The panel assembly 16 may further include a damper mechanism, indicated schematically at 77 in FIG. 2, for damping the movement of the extension panel 62 when moving to its retracted position so that the extension panel 62 does not forcefully hit the bottom the recess 64 of the base panel 60 by the force exerted by the spring member 76. The extension panel 62 may be moved manually or may include other devices, such as hydraulic, pneumatic, and electrical actuators for moving the extension panel 62 between its lowered and lifted positions. For manual movement, the extension panel 62 may include a handle 80 extending therefrom for assisting in manually moving the extension panel 62. As shown in the embodiment of the panel assembly 16, the base panel 60 includes a slot 82 formed thereon for accommodating the movement of the handle 80.

Although the base panel 60 and the extension panel 62 are shown as having a relatively flat rectangular shape, they can have any suitable shape for generally covering at least a portion of the recess 12.

The panel assembly 16 preferably further includes a base latch, indicated schematically at 90, for selectively maintaining the base panel 60 in its lowered position. The base latch 90 is operable between a latched position preventing movement of the base panel 60 from its lowered position, and an unlatched position to permit movement of the base panel 60 from its lowered position. The panel assembly 16 also preferably includes an extension latch 96 for selectively maintaining the extension panel 62 in its extended position. The extension latch 96 is operable between a latched position preventing movement of the extension panel 62 from its extended position, and an unlatched position to permit movement of the extension panel 62 from its extended position. Any suitable device may be used for the latches 90 and 96. For example, as best shown in FIG. 5, the latches 90 and 96 may include respective catch mechanisms 90a and 96a mounted on the floor 20 which cooperate with engagement members 90b and 96b mounted on the panels 60 and 62, respectively. The latches 90 and 96 may be operated by manually operated levers and/or cable operated mechanisms (not shown). Alternatively, the latches 90 and 96 may be operated by electrical devices, such as solenoid actuators. The latches 90 and 96 may also be moved to their latched and unlatched positions caused by movement of various components of the assembly 10, such as for example, movement of the seat back 32 or movement of the extension panel 62 as will be explained below.

The operation of the assembly 10 will now be explained. In FIG. 1, the seat assembly 12 is shown in its upright position for supporting an occupant. As best shown in FIG. 2, the base panel 60 when in its lowered position generally covers a front portion 22a of the recess 22, and the extension panel 62 when in its extended position generally covers a rear portion 22b of the recess 22. The base and extension panels 60 and 62 function as a load floor and are preferably generally co-planar with the adjacent portions of the floor 20. To store the seat assembly 12 within the recess 22, the seat back 32 is moved from its upright position to its lowered position above the seat bottom 30, as shown in FIG. 3. The seat back 32 may be manually moved from its upright position to its lowered position, or more preferably, the seat back latch 35 is actuated to automatically cause the biased seat back 32 to move to its lowered position.

Next, the extension latch 96 is operated from its latched position to its unlatched position. The extension latch 96 can be operated manually or may be automatically caused by movement of the seat back 32 to its lowered position. For example, the seat back latch 35 may be connected to the extension latch 96, such as by a Bowden cable (not shown) such that actuation of the seat back latch 35 also causes simultaneous actuation of the extension latch 96. Alternatively, a mechanism (not shown) may detect when the seat back 32 is moved to its lowered position, and then actuate the extension latch 96 to its unlatched position.

Upon actuation of the extension latch 96 to its unlatched position, the spring 76 preferably automatically moves the extension panel 62 to its retracted position, as shown in FIG. 3. Once the extension panel 62 is in its retracted position, the base panel 60 can be moved from its lowered position to its lifted position, as shown in FIG. 4. To move the base panel 60 to its lifted position, the base latch 90 is actuated to its unlatched position. The base latch 90 can be operated manually or may be automatically caused by movement of the extension panel 62 to its retracted position. For example, the base latch 90 may be connected to a trigger member (not shown) attached to the extension panel 62 such that movement of the extension panel 62 to its retracted position causes simultaneous actuation of the base latch 90.

Upon actuation of the base latch 90 to its unlatched position, the spring loaded hinge assembly 70 preferably automatically moves the base panel 60 to its lifted position, as shown in FIGS. 4 and 5. Note that when the extension panel 62 is in its retracted position, the base panel 60 can be pivoted upwardly, thereby clearing a front portion of the seat bottom 30 even though the seat assembly 12 is in its upright position. It should be understood that the entire extension panel 62 need not be retracted fully in the recess 64 and that a first end portion 100 of the extension panel 62 may still extend outwardly from the recess 64 when the extension panel 62 is in its retracted position, as shown in FIG. 5. The extension panel 62 includes the first end portion 100, a second end portion 102, and an intermediate portion 104 between the first and second end portions 100 and 102. The intermediate portion 104 is adjacent to and within the recess 64 of the base panel 60 when the extension panel is in its retracted position. The intermediate portion 104 extends outwardly from the base panel 60 when the extension panel is in its extended position.

The lifted position of the base panel 60 can be any position which provides clearance for moving the seat assembly 10 to its stowed position within the recess 22. Once the base panel 60 is in its lifted position, the seat assembly 12 may be moved from its upright position to its stowed position within the recess 22, as shown in FIGS. 4-7. The seat assembly 12 may be moved manually. The seat assembly 12 preferably includes a seat latch (not shown) for locking the seat bottom 30 relative to the mounting assembly 36. Upon actuation of the seat latch, which may be connected with the seat back latch 35, the front and rear legs 42 and 44 may be pivoted to move the seat assembly 12 from its upright position to its stowed position, as shown in FIG. 4.

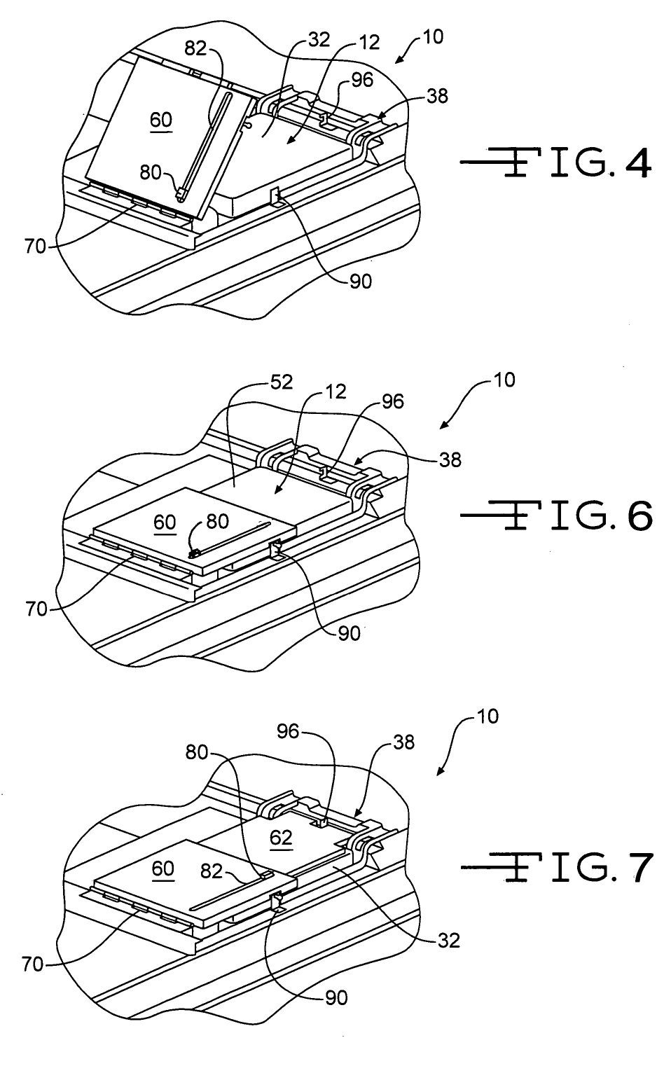

After the seat assembly 12 is in its stowed position, the base panel 60 can be moved from its lifted position to its lowered position, as shown in FIG. 6. The base panel 60 may be manually lowered with sufficient force to overcome the force exerted by the spring loaded hinge assembly 70. The base latch 90 is then actuated to its latched position. This actuation may be caused by simply moving the base panel 60 to its lowered position. For example, the base latch 90 may include the engagement member 90b mounted on the base panel 60 which mates with the catch mechanism 90a mounted on the floor 20.

The extension panel 62 may then be moved to its extended position, as shown in FIG. 7, thereby generally covering the stowed seat assembly 12 and the recess 22. In this position, the panel assembly 16 functions as a load floor. The extension panel 62 may be moved manually by use of the handle 80 with sufficient force to overcome the force exerted by the spring member 76. The extension latch 96 is then actuated to its latched position. This actuation may be caused by simply moving the extension panel 62 to its extended position. For example, the extension latch 96 may include the engagement member 96b mounted on the first end portion 100 of the extension panel 60 which mates with the catch mechanism 96a mounted on the floor 20.

To remove the seat assembly 12 from out of the recess 22 to its upright position, the extension latch 96 is actuated to its unlatched position. The spring 76 preferably automatically moves the extension panel 62 to its retracted position, which causes actuation of the base latch 90 to its unlatched position. The base panel 60 can then be moved to its lifted position by the spring loaded hinge assembly 70. The seat assembly 12 can then be moved manually by lifting the seat assembly 12 upwardly, thereby causing pivoting action of the front and rear legs 42 and 44. Once the seat assembly 12 is in its upright position, the base panel 60 can be moved from its lifted position to its lowered position. The base latch 90 is then actuated to its latched position. The extension panel 62 may then be moved to its extended position.

When the seat assembly 12 is in its upright position, the panel assembly 16 can still be moved to access the recess 22. Thus, the recess 22 can function as a storage area if the seat assembly 12 is not stowed in the recess 22. Alternatively, the seat assembly 12 may not even be movably mounted for storage within the recess 22, and as such the panel assembly 16 is used to cover a storage area under the seat assembly 12 defined by the recess 22.

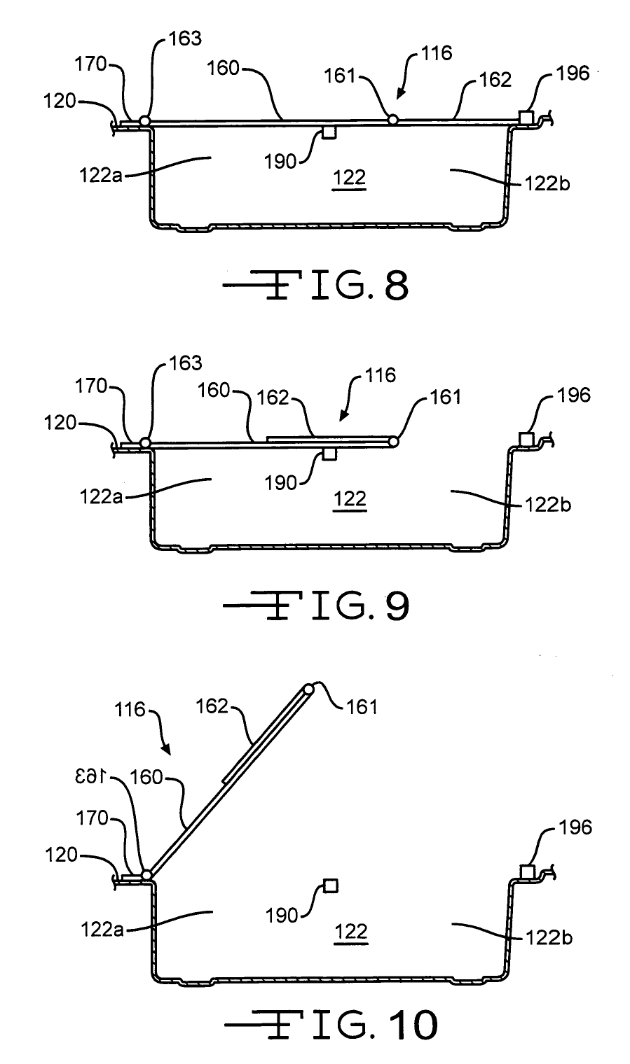

There is schematically illustrated in FIGS. 8 through 10 an alternate embodiment of a panel assembly 116. The panel assembly 116 is pivotally mounted on a vehicle floor 120 by a hinge assembly 170. The floor 120 includes a recess 122. A seat (not shown) similar to the seat assembly 12 described above, may be mounted on the floor 120 and movable between an upright position above the recess 122 and a stowed position within the recess 122. Like the panel assembly 16, the panel assembly 116 is movable to expose the recess 122 and to cover the recess 122 thereby providing a load floor over the recess 122.

The panel assembly 116 includes a base panel 160 and an extension panel 162. The extension panel 162 is pivotally mounted on the base panel 160 at a pivot 161. The base panel 160 may be pivotally mounted on the floor 120 at a pivot 163. The base panel 160 is movable between a lowered position as shown in FIGS. 8 and 9, and a lifted position as shown in FIG. 10. The extension panel 162 is movable between an extended position as shown in FIG. 8 such that the extension panel 162 extends outwardly from the base panel 160, and a retracted position as shown in FIGS. 9 and 10 adjacent the base panel 160. As shown in FIG. 8, the base panel 160 when in its lowered position generally covers a front portion 122a of the recess 122, and the extension panel 162 when in its extended position generally covers a rear portion 122b of the recess 122.

A base latch 190 may be used to selectively maintain the base panel 160 in its lowered position. An extension latch 196 may be used to selectively maintain the extension panel 162 in its extended position.

The movement of the base and extension panels 160 and 162 are preferably automatic when moving from positions illustrated in FIG. 8 to the positions illustrated in FIG. 10. The panel assembly 116 may include spring mechanisms (not shown), such as coil springs located at the pivots 161 and 163, to bias the base panel 160 in its lifted position and to bias the extension panel 162 in its retracted position.

To move the panel assembly 116 from its position shown in FIG. 8 to uncover the recess 122, the extension latch 196 is operated to its unlatch position. The extension panel 162 will automatically move from its extended position to its retracted position, as shown in FIG. 9. Preferably, movement of the extension panel 162 to its retracted position operates the base latch 190 to its unlatched position, thereby automatically moving the base panel 160 to its lifted position, as shown in FIG. 10. Thus, the panel assembly 116 can be operated to expose the recess 122 by simply operating the extension latch 196 as opposed of manually moving the panels 160 and 162 through their various positions.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A panel assembly for covering a storage recess in a vehicle floor, said assembly comprising:
a base panel adapted to be movable relative to the recess to cover a first portion of the recess; and
an extension panel slidably mounted on said base panel and movable with said base panel, said extension panel being slidable between a retracted position in which a portion of said extension panel is adjacent said base panel, and an extended position such that said portion of said extension panel extends outwardly from said base panel and is adapted to cover a second portion of the recess.

2. The assembly of claim 1, wherein said base panel includes a recess formed therein, and wherein said extension panel is slidably disposed in said recess of said base panel.

3. The assembly of claim 1, wherein said extension panel is biased towards said retracted position.

4. The assembly of claim 3, wherein said panel assembly includes a damper mechanism for damping movement of said extension panel when said extension panel moves towards said retracted position.

5. The assembly of claim 1, wherein said extension is manually movable between said retracted and extended positions.

6. The assembly of claim 5, wherein said base panel includes a slot formed therein, and wherein said extension panel includes a handle extending outwardly therefrom and disposed in said slot.

7. The assembly of claim 1, wherein said base panel is adapted to be movable between a lowered position covering the first portion of the storage recess, and a lifted position exposing the portion of the storage recess.

8. The assembly of claim 7 further including a base latch operable between a latched position to prevent movement of said base panel from said lowered position, and an unlatched position to permit movement of said base panel from said lowered position.

9. The assembly of claim 7, wherein said base panel is adapted to be pivotally mounted on the vehicle floor.

10. The assembly of claim 1 further including an extension latch operable between a latched position to prevent movement of said extension panel from said extended position, and an unlatched position to permit movement of said extension panel from said extended position.

11. The assembly of claim 10 further including a seat assembly having a seat bottom and a seat back pivotally mounted relative to said seat bottom, said seat back movable between an upright position and a lowered position resting against said seat bottom, and wherein movement of said seat back to said lowered position causes said extension latch to operate in said unlatched position.

12. The assembly of claim 11 further including a spring biasing said extension panel towards said retracted position such that movement of said seat back to said lowered position causes said extension panel to automatically move to said retracted position.

13. The assembly of claim 12, wherein said base panel is adapted to be movable between a lowered position covering the first portion of the storage recess, and a lifted position exposing the first portion of the storage recess, and wherein said assembly further includes a base latch operable between a latched position to prevent movement of said base panel from said lowered position, and an unlatched position to permit movement of said base panel from said lowered position, and wherein movement of said extension panel to said retracted position causes said base latch to operate in said unlatched position.

14. The assembly of claim 13, wherein said base panel is biased towards said lifted position, such that movement of said extension panel to said retracted position causes said base panel to move from said lowered position to said lifted position.

15. The assembly of claim 11 further including a second latch to selectively latch said base panel in said lowered position.

16. The assembly of claim 1, wherein said assembly further includes a seat movable between an upright position above said vehicle floor, and a stowed position disposed in said storage recess.

17. A vehicle assembly comprising:
a floor having a storage recess formed therein, said storage recess defining first and second portions;
a seat assembly movable between an upright position above said vehicle floor, and a stowed position disposed in said storage recess;
a panel assembly including a base panel having a panel recess formed therein and an extension panel slidably disposed in said panel recess, said base panel movable between a lowered position covering said first portion of said storage recess, and a lifted position exposing said first portion of said storage recess, said extension panel movable between a retracted position such that a portion of said extension panel is disposed in said recess of said base panel, and an extended position such said portion of said extension panel is disposed out from said recess covering said second portion of said storage recess when said base panel is in said lowered position.

18. The assembly of claim 17, wherein said seat includes:
a seat bottom having a seating surface for supporting an occupant;
a seat back having a seating surface for supporting an occupant, said seat back movably mounted relative to said seat bottom between an upright position, wherein said seat back is in a generally vertical position for supporting an occupant, and a lowered position wherein said seating surface of said seat back faces said seating surface of said seat bottom; and
a mounting assembly for mounting said seat bottom to said floor of the vehicle, said mounting assembly including:
a first leg having a first portion pivotally mounted on said seat bottom, and a second portion pivotally mounted relative to said floor; and
a second leg having a first portion pivotally mounted on said seat bottom, and a second portion pivotally mounted relative to said floor, wherein said seat bottom is movably mounted relative to said floor by said mounting assembly between a seating position above said recess and a stowed position within said recess, wherein said seating surface of said seat bottom faces upward in both said seating and stowed positions.

19. A panel assembly for covering a storage recess in a vehicle floor, said assembly comprising:
a base panel adapted to be movable relative to the recess to cover a first portion of the recess; and
an extension panel movably mounted relative to said base panel, said extension panel being movable between a first position in which a portion of said extension panel is adjacent said base panel, and a second position such that said portion of said extension panel extends outwardly from said base panel and is adapted to cover a second portion of the recess, wherein said extension panel is biased towards said retracted position by a spring; and
an extension latch operable between a latched position to prevent movement of said extension panel from said extended position, and an unlatched position to permit movement of said extension panel from said extended position, wherein said extension panel is automatically moved from said extended position to said retracted position by said spring upon the latch being operated to said unlatched position.

20. The assembly of claim 19, wherein said base panel is adapted to be movable between a lowered position covering the first portion of the storage recess, and a lifted position exposing the first portion of the storage recess such that said base panel is biased to said lifted position by a second spring,
and wherein said assembly further includes a base latch operable between a latched position to prevent movement of said base panel from said lowered position, and an unlatched position to permit movement of said base panel from said lowered position, and wherein movement of said extension panel to said retracted position causes said base latch to operate in said unlatched position.
